(19) United States
(12) Patent Application Publication
(10) Pub. No.: US 2017/0370526 A1
(43) Pub. Date: Dec. 28, 2017

(54) Device and a Method for Improving Safety in a Cutting Saw Apparatus

(71) Applicants: Robert Bosch GmbH, Stuttgart (DE); Robert Bosch Engineering and Business Solutions Private Limited, Bangalore (IN)

(72) Inventor: Harikrishnan Mahadevan, Trivandrum (IN)

(21) Appl. No.: 15/629,881

(22) Filed: Jun. 22, 2017

(30) Foreign Application Priority Data
Jun. 24, 2016 (IN) 201641021752

(51) Int. Cl. F16P 3/12; B27B 5/38; B23D 59/00

(52) U.S. Cl. CPC F16P 3/12; B27B 5/38; B23D 59/001

(57) ABSTRACT

A system and a method for improving safety in a cutting saw apparatus is disclosed. The system comprises an RC oscillation circuit connected to a cutting saw, a detection module to detect changes in the output of the circuit and a control module that controls the operation of the cutting saw. The user wears a conductive footwear when working with the cutting saw. The system also comprises a conductive layer disposed beneath the conductive footwear and the oscillation circuit to establish a conductive path. The user also wears hand gloves to enable working with conductive, non-conductive and semi-conductive materials. When the user's hands comes into contact with the cutting saw, the resistance characteristics of the circuit changes, resulting in a change in the output signal of the circuit. This change is detected by the detection module which triggers the control module to stop the cutting saw.

### FIELD OF THE INVENTION

This invention relates to a device and a method for improving safety in a cutting saw apparatus.

### BACKGROUND OF THE INVENTION

Cutting saw systems are commonly used for cutting materials like wood etc., Cutting saw systems usually comprise a saw or a cutting element in the form of a wheel which is held rotatably in the cutting saw system. The user moves the material to be cut towards the saw for the purposes of cutting. In doing so, there are chances of the user's hands coming into contact with the saw, which can prove to be disastrous and dangerous for the user. U.S. Pat. No. 5,510,685 discloses a safety mechanism for the user, integrated with the cutting saw system, which, upon detection of the user coming into contact with the saw, stops and retracts the saw into a cavity in the system.

### BRIEF DESCRIPTION OF DRAWINGS

Embodiments of this disclosure is explained in principle below with reference to the drawings. The drawings are:

FIG. 1 illustrates a schematic of a system for improving safety in a cutting saw apparatus; and

FIG. 2 illustrates a method for improving safety in a cutting saw apparatus

### DETAILED DESCRIPTION

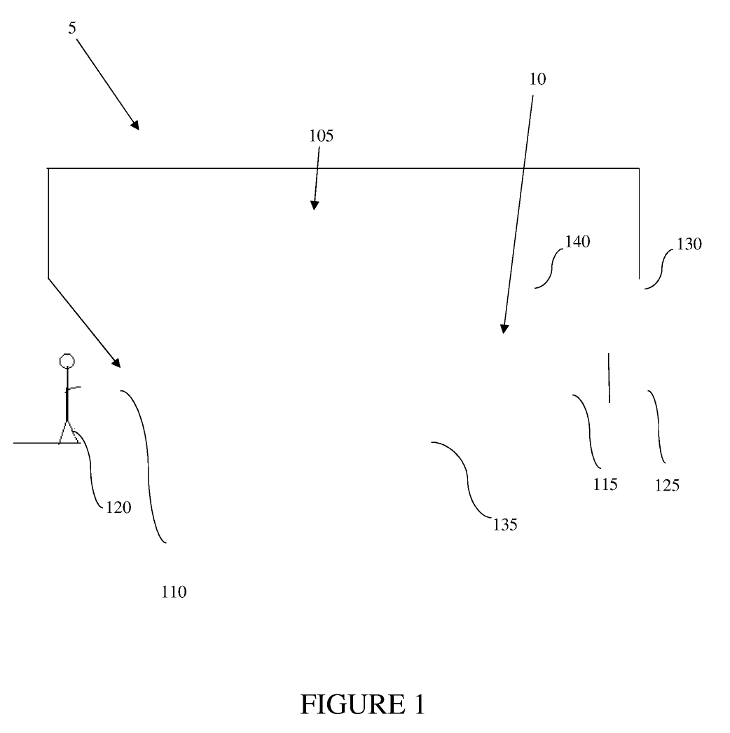

FIG. 1 illustrates a schematic of a system 5 for improving safety for a cutting saw apparatus. The system 5 comprises a device 10 for improving safety in a cutting saw apparatus. The system 5 is a part of the cutting saw apparatus, wherein the cutting saw apparatus comprises other components as well. The device 10 comprises a RC oscillation circuit 105 connected to a cutting saw 110. The device 10 also comprises a detection module 115 connected to the RC oscillation circuit 105 to detect a change in an electrical output of the RC oscillation circuit 105 upon creation of a conductive path between the cutting saw 110 and a user 120. The device 10 further comprises a control module 125 connected to the detection module 115 and a drive 130 of the cutting saw 110 for stopping the cutting saw, upon the detection module 115 detecting the change in the electrical output of the RC oscillation circuit 105. The working of the device 10 will be described hereinafter.

The RC oscillation circuit 105 comprises a set of resistors, capacitors and an op-amp. In the RC oscillation circuit 105, typical exemplary values of the bridge resistors can be 10 kΩ, the capacitors can be 1 nF and the voltage limiting resistor in the amplifier feedback loop can be 290 kΩ. As indicated, these are just exemplary values and the resistors and capacitors in the RC oscillation circuit 105 can take on different values as well. Different values of the resistors and capacitors provide different characteristics for the RC oscillation circuit 105. The RC oscillation circuit 105 is an RC phase shift oscillator whose output frequency depends on the resistance connected in the feedback circuit and ground.

The detection module 115 comprises a signal processing circuitry, which processes and compares the input waveforms of the detection module 115 to detect any changes.

The system 5 further comprises a conductive layer 135 for supporting the user and basing a ground of the RC oscillation circuit 105. In order to establish a conductive path between the cutting saw 110 and the user 120, the user 120 has to wear a conductive footwear (not shown in Figures). The conductive footwear can be in the form of a conductive shoe or a removable base for the feet that is conductive. Similarly, a pair of hand gloves (not shown in Figures) with an internal metallic mesh lining, has to be worn by the user 120. The purpose and working of the gloves will be described hereinafter.

The system 5 further comprises an insulator (not shown in Figures) disposed between the conductive layer 135 and earth, the purpose of which will be described hereinafter.

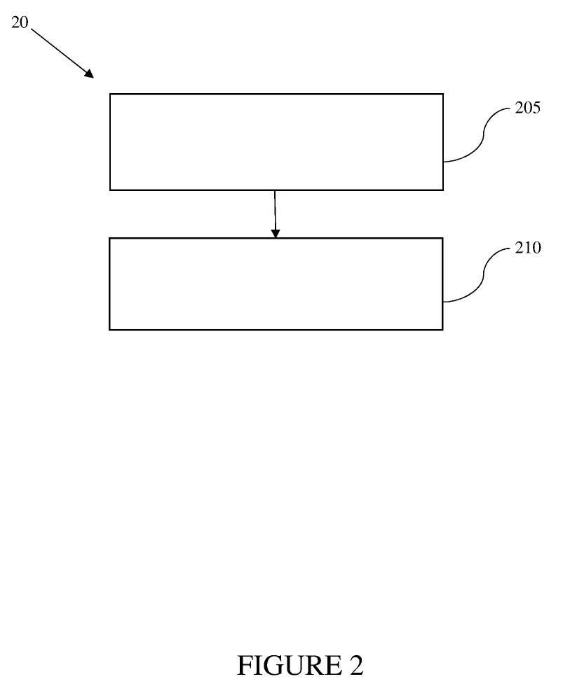

FIG. 2 illustrates a method 20 for improving safety in a cutting saw apparatus. The method 20 is carried out by the device 10 and comprises a first step 205 of detecting a change in an electrical output of the RC oscillation circuit 105, by the detection module 115, upon creation of a conductive path between the cutting saw 110 and the user 120. The method 20 comprises a second step 210 of stopping the cutting saw 110 by controlling the drive 130 of the cutting saw 110 by the control module 125. The working of the method 20 will be described hereinafter.

The purpose of the conductive footwear arranged to be worn by the user 120 is to form a conductive path between the user 120 and the conductive layer 135. The conductive layer 135 connects the ground of the RC oscillation circuit 105 and the conductive footwear, thereby forming a conductive path between the RC oscillation circuit 105 and the user 120, when wearing the conductive footwear. The purpose of the insulator is to insulate the conductive layer 135, and more specifically the system 5 and the user 120, from earth to improve the safety during any case of electrical leakage accidents, etc.

The purpose of the pair of hand gloves, if worn by the user, is to insulate and also protect the user from the cutting saw 110. Usually, when the user 120 is cutting non-conducting materials like wood etc., the user 120 is naturally insulated from the cutting saw 110. However, when the user 120 is cutting conducting or semi-conducting materials, the pair of hand gloves worn by the user 120 help in insulating the user 120 from the cutting saw 110. But, by wearing the hand gloves when cutting conducting, non-conducting or semi-conducting materials, the user 120 is insulated from the cutting saw 110. Hence, the technical advantage of using the pair of hand gloves is that it allows usage of the system 5 for conducting, semi-conducting and non-conducting materials.

The purpose of the internal metallic mesh lining of the pair of hand gloves is to physically protect the fingers or palm of the user when the cutting saw 110 accidentally comes into contact with an outer surface of the hand gloves and cuts the outer surface of the hand gloves. The other advantage of the metallic mesh lining is to include the user 120 in the RC oscillation circuit 105 to change the output characteristics of the circuit 105 to enable detection and stop the cutting saw 110 before the cutting saw 110 touches the fingers and palm of the user 120, which will be explained hereinafter.

When the user 120 is cutting any type of material with the pair of hand gloves on, the user 120 will be insulated from the circuit 105 and the output of the RC oscillation circuit 105 as detected by the detection module 115 will be in line with the designed output characteristics of the circuit 105 in terms of the output signal waveform. This is because the user 120 is not included in the circuit 105. When the cutting saw apparatus is being used, the detection module 115 will be constantly receiving the output from the circuit 105 and checking if the received waveform conforms to the designed output waveform within a specified tolerance level. Now, if the user 120 accidentally moves his hands close to the cutting saw 110 during cutting, the cutting saw 110 can abrade or cut the outer surface of the hand glove and make contact with either the internal metallic mesh liming, or in case the metallic lining is absent, the fingers or palm of the user 120 directly. Either of the above two cases can bring the user 120 in contact with the cutting saw 110. The user 120 being a human and being conductive, therefore forms a conductive path between the cutting saw 110 and the conductive layer 135. The user 120 is therefore included in the circuit 105 and the resistance characteristics of the circuit 105 changes, thereby consequently changing the electrical output and more specifically, the output signal waveform of the circuit 105. To elaborate, inclusion of the human resistance of the user 120 can cause a change in the attenuation provided by a feedback circuit of the RC oscillation circuit 105, resulting in a change in an amplitude of the electrical output of the RC oscillation circuit 105. Examples of other changes of the electrical output of the RC oscillation circuit 105 can be a clipped sine wave of the output signal waveform, increased amplitude of the sine wave of the output signal waveform or a died out signal.

The detection module 115 which is continuously receiving the electrical output from the RC oscillation circuit 105 detects a change in the above mentioned electrical output, upon creation of the conductive path between the cutting saw 110 and the user 120. In other words, the detection module 115 detects a change in the above mentioned electrical output, upon inclusion of the user 120 in the RC oscillation circuit 105. To elaborate on the above, the signal processing circuitry of the detection module 115 receives, processes the electrical output or the output signal waveform of the RC oscillation circuit 105 and compares the same with a predefined or control signal waveform to detect the creation of the conductive path between the cutting 110 and the user 120 or the inclusion of the user 120 in the RC oscillation circuit 105.

The above describes the step 205 of the method 20.

The system 5 also comprises a power control module 140 for providing power to the RC oscillation circuit 105 and the cutting saw 110.

Upon detection of the change in the electrical output of the RC oscillation circuit 105 by the detection module 115, the detection module 115 communicates with the control module 125 or commands the control module 125 to stop the cutting saw 110. Subsequently, the control module 125 controls the drive 130 of the cutting saw 110 to stop the cutting saw 110. Additionally, the drive 130 can also retract the cutting saw 110 from a cutting position to provide improved protection to the user 120. This is understood by the person of ordinary skill in the art. This describes the step 210 of the method 20.

Large current and voltage levels cannot be used in the detection circuitry, due to the presence of the human as a user, due to obvious reasons. With the omnipresent nature of electrical noise in circuits and with low intensity current and voltage levels, detection of change in the signal output becomes less accurate, if there is a saw-human contact, thereby leading to disastrous effects for the user. The RC oscillation circuit 105 with reduced noise output characteristics is advantageous because it allows improved accuracy of detection with low intensity current and voltage levels in the circuit.

The system 5 can also learn the difference between ‘normal condition’ and ‘accident condition’ before the user 120 starts using the system 5, which can be referred to as a learning routine. The ‘accident condition’ is a simulation of a saw-human contact scenario, wherein the cutting saw 110 comes into contact with the fingers of the palm of the user 120 or the internal metallic mesh lining of the hand gloves. To simulate the ‘normal condition’, the user 120 makes contact with a metallic element connected to the saw with the pair of hand gloves and the detection module 115 receives the output signal from the RC oscillation circuit 105, the characteristics of which will be more or less the same as the designed characteristics of the output signal. To simulate the ‘accident condition’, the user 120 makes contact with a metallic element connected to the saw without the hand gloves and the detection module 115 receives the output signal from the RC oscillation circuit 105, the characteristics of which will be quite different from the output signal in the ‘normal condition’. This information is saved in a suitable memory device in the system 5 and used under real-time conditions when actual detection is required. This enables the detection module 115 to learn the difference in the characteristics of the output signal waveform between ‘normal condition’ and ‘accident condition’. The resistance values of different human beings are different and therefore the bodies of different users can cause different changes in the output signal waveform. Hence, before a user starts using the cutting saw apparatus in which the system 5 is embodied, a learning routine as described above can be run to store the values.

It is to be understood that the foregoing description is intended to be purely illustrative of the principles of the disclosed techniques, rather than exhaustive thereof, and that changes and variations will be apparent to those skilled in the art, and that the present invention is not intended to be limited other than as expressly set forth in the following claims.

1. A device for improving safety in a cutting saw apparatus, the device comprising:
a RC oscillation circuit connected to a cutting saw;
a detection module connected to the RC oscillation circuit, the detection module configured to detect a change in an electrical output of the RC oscillation circuit that indicates a upon creation of a conductive path between the cutting saw and a user; and
a control module connected to the detection module and a drive of the cutting saw, the control module configured to stop the cutting saw in response to detecting the change in the electrical output of the RC oscillation circuit with the detection module.

2. A system for improving safety for a cutting saw apparatus, the system comprising:
a device comprising:
a RC oscillation circuit connected to a cutting saw;
a detection module connected to the RC oscillation circuit, the detection module configured to detect a change in an electrical output of the RC oscillation circuit that indicates a creation of a conductive path between the cutting saw and a user; and
a control module connected to the detection module and a drive of the cutting saw, the control module configured to stop the cutting saw in response to detecting the change in the electrical output of the RC oscillation circuit by with the detection module; and
a conductive layer configured to support for supporting the user and act as basing a ground of the RC oscillation circuit.

3. The system as claimed in claim 2 further comprising:
an insulator disposed between the conductive layer and earth.

4. The system as claimed in claim 2 further comprising:
conductive footwear worn by the user.

5. The system as claimed in claim 2 further comprising:
a pair of hand gloves worn by the user.

6. The system as claimed in claim 5, wherein the pair of hand gloves include an internal metallic mesh lining.

7. A method of improving safety in a cutting saw apparatus, the cutting saw apparatus comprising a device having a RC oscillation circuit connected to the cutting saw, the method comprising:
detecting a change in an electrical output of the RC oscillation circuit that indicates creation of a conductive path between the cutting saw and a user; and
stopping the cutting saw with a control module in response to detecting the change in the electrical output of the RC oscillation circuit.
